(19) United States
(12) Patent Application Publication
(10) Pub. No.: US 2025/0179962 A1
(43) Pub. Date: Jun. 5, 2025

(54) POWER PLANT PROVIDED WITH A TURBOSHAFT ENGINE AND AN ADAPTIVE STARTING CIRCUIT AND ADAPTIVE STARTING METHOD FOR A TURBOSHAFT ENGINE

(71) Applicant: AIRBUS HELICOPTERS, Marignane Cedex (FR)

(72) Inventor: Marc GAZZINO, Marseille (FR)

(73) Assignee: AIRBUS HELICOPTERS, Marignane Cedex (FR)

(21) Appl. No.: 18/888,760

(22) Filed: Sep. 18, 2024

(30) Foreign Application Priority Data
Dec. 5, 2023 (FR) 2313576

(51) Int. Cl. F02C 7/275; F02C 7/268

(52) U.S. Cl. CPC F02C 7/275; F02C 7/268

(57) ABSTRACT

An adaptive starting method for a turboshaft engine comprising a gas generator, an electric machine connected mechanically to the gas generator and electrically to one or more electrical energy sources. A maximum electrical intensity of an electric current that can be delivered by the electrical energy hgsource or sources is determined as a function of at least one characteristic of each electrical energy source, a maximum engine torque supplied by the electric machine powered by each electrical energy source with the maximum electrical intensity is determined. The maximum engine torque is compared with a required engine torque envelope permitted by the gas generator. The maximum electrical intensity of the electric current supplied by the electrical energy source or sources is adapted in order to comply with the required envelope in order to start the gas generator.

### CROSS REFERENCE TO RELATED APPLICATIONS

This application claims priority to French patent application no. FR 23 13576 filed on Dec. 5, 2023, the disclosure of which is incorporated in its entirety by reference herein.

### TECHNICAL FIELD

The disclosure lies in the technical field of heat engines, in particular turboshaft engines.

### BACKGROUND

The present disclosure relates to a power plant provided with a turboshaft engine and an adaptive starting circuit, and an adaptive starting method for a turboshaft engine.

A turboshaft engine conventionally comprises a gas generator and at least one power turbine. The gas generator is provided, successively, with a compressor, a fuel combustion chamber and at least one expansion turbine constrained to rotate with the compressor by a connecting shaft. The power turbine may be free, i.e., not mechanically constrained to rotate with the expansion turbine and compressor or, therefore, with the gas generator. The power turbine is then rotated by the gases exiting the expansion turbine of the gas generator. Alternatively, the power turbine may be mechanically constrained to rotate with the expansion turbine, and therefore with the gas generator.

In all cases, the power turbine mechanically rotates an output shaft of the turboshaft engine. A turboshaft engine may equip an aircraft, its output shaft being able to be connected, via a gearbox, to a propeller or to a rotor, for example.

In order to start the turboshaft engine, the compressor needs to be rotated in order to generate pressurized air that is injected into the combustion chamber, and the gases generated by the combustion of a fuel in the combustion chamber then rotate the expansion turbine. This rotation of the compressor is initiated by a starter connected mechanically in rotation to a drive shaft of the compressor. This starter may be a simple electric motor or a reversible electric machine referred to as a “starter/generator”. Furthermore, when the compressor is set in rotation, its speed of rotation must not increase too quickly in order not to blow out, i.e., extinguish, the flame generated during the first combustion of the fuel in the combustion chamber.

In for order the turboshaft engine to operate independently, the speed of rotation of the expansion turbine must exceed a threshold in order for the air injected into the combustion chamber to be sufficiently compressed.

Furthermore, during starting, the speed of rotation of a starter constituted by a commutator/brush DC machine increases gradually, causing its counter-electromotive force to increase. The electrical intensity of the electric current supplying this type of starter, that cannot be acted upon to vary the torque, then decreases as its speed of rotation increases.

The engine torque supplied by such a starter and setting the drive shaft of the compressor in rotation cannot be controlled and is proportional to the electric current supplying this starter. Therefore, when starting a turboshaft engine, this engine torque may have a high peak at the beginning of the starting phase, then decreases as the speed of rotation of the starter and its counter-electromotive force increase.

The electrical voltage of this electric current is related to the power source. When this source is an electric battery, this electrical voltage drops when the starter is switched on, then increases proportionally to the decrease in the electrical intensity of this electric current supplying the starter.

Moreover, a resistive torque of the gas generator, generated by the compressor and the expansion turbine, tends to counter this rotation of the drive shaft of the compressor set by the starter. It is therefore necessary to supply sufficient electrical energy to the starter to drive the compressor, with an engine torque that is greater than the resistive torque.

Conversely, this engine torque must not be too great in order not to cause the gas generator to accelerate too quickly, in particular in order not to extinguish the combustion chamber. Moreover, an engine torque that is too great may damage the mechanical connection between the starter and the drive shaft of the compressor.

In this context, the engine torque of the starter for starting a turboshaft engine needs to be between a minimum torque and a maximum torque.

Moreover, the starter is supplied with electrical energy by one or more electrical energy sources, such as, for example, an electric battery or an electricity network. In the case of a turboshaft engine of a vehicle, and an aircraft in particular, one or more on-board electric batteries may supply electricity to the starter.

The electrical energy that can be supplied by the electric batteries used as electrical energy sources may vary as a function of their temperature, this electrical energy decreasing with the temperature, their state of charge or their ageing. At low temperatures, an electric battery may therefore be incapable of allowing a turboshaft engine to be started.

Moreover, when starting, the high level of electrical energy required by the starter may also result in a significant drop in the electrical voltage at the terminals of an electric battery, due to the internal electrical resistance of the electric battery. The higher the electric current consumed by the starter is, the more the electrical voltage drops. This drop in the electrical voltage may vary as a function, for example, of the temperature and the state of charge of the electric battery.

Using several electric batteries in parallel may help mitigate these consequences. However, at high temperatures and/or high charge levels, the electrical energy supplying the starter may be too great, the starter then being likely to generate an engine torque greater than the high threshold referred to above.

Therefore, using a set of electrical energy sources capable of ensuring the effective starting of a turboshaft engine at both low and high temperatures, and with various charge levels, is a complex operation.

Document EP 2390485 describes a method for controlling the starting of a turboshaft engine that consists in defining electric current setpoints for a starter as a function of a starting torque previously determined for the gas turbine, and modulating an electrical intensity of the electric current supplying the starter in order to obtain the desired starting torque.

Document EP 3043445 describes an electric circuit of a rotorcraft controlling the supply of electrical energy for starting a turboshaft engine by using several electrical energy sources. The electrical energy sources comprise a main source provided with electric batteries and a secondary source comprising a discharge module. A static bi-directional DC/DC converter, mounted in series with the discharge module, makes it possible to control the operation of this discharge module as a function of the value of at least one parameter identifying the evolution of the starting phase of the turboshaft engine.

Document EP 1556597 relates to an electric machine used as a starter/generator in an airplane. This electric machine comprises a stator provided with several windings supplied with electric current by an electrical energy source. One or more switches and an electrical energy source are controlled selectively in order to electrically connect a capacitor in series with one or more of these windings so as to supply additional electrical energy to the windings of the stator such that the electric machine generates an engine torque that is sufficiently high to start an engine of the airplane.

Document WO 2022/208021 relates to a method and a system for starting a turboshaft engine comprising an electric machine and a control system converting DC electrical voltage into three-phase electrical voltage in order to rotate the electric machine at a defined speed.

Document FR 3015571 describes a system for starting a turbomachine comprising a battery, a DC starter, an electronic control calculator, and a transmission relay. First and second circuits are mounted in parallel and interposed between the battery and the starter. The first circuit comprises a DC/DC converter mounted in series with a first circuit switch and the second circuit comprises a second circuit switch. The system also comprises a sensor for sensing the speed of rotation of the compressor of the turbomachine and a sensor for sensing the temperature at the inlet of the free turbine of the turbomachine and a control circuit for controlling the first and second circuit switches as a function of the information supplied by these two sensors.

Documents EP 1865172, EP 2554799, EP 3186489, FR 3101918, EP 2295726, EP 0911515, FR 3076322 and US 2011/0042969 are far removed from the disclosure.

### SUMMARY

An object of the present disclosure is thus to allow a gas generator of a turboshaft engine to be started without the risk of damage to mechanical parts, at both low temperatures and high temperatures.

The disclosure therefore relates to an innovative method for starting a power plant provided with a turboshaft engine and a power plant that can be used to implement such a method.

An object of the present disclosure is, first and foremost, an adaptive starting method for a turboshaft engine comprising a gas generator, an electric machine connected mechanically to a drive shaft of the gas generator and electrically to an electric generator provided with at least one electrical energy source.

The electric machine therefore acts as a starter or starter/generator for the gas generator of the turboshaft engine. The electric machine is connected mechanically to the drive shaft of the gas generator, via a mechanical transmission system likely to comprise a speed reduction system, obtained by means of gears, pinions and/or toothed wheels, for example.

The method is remarkable in that it comprises the following steps:
determining a maximum electrical intensity of an electric current that can be delivered by the electric generator as a function of at least one characteristic of said at least one electrical energy source;
calculating a maximum engine torque supplied by the electric machine to the drive shaft when the electric machine is supplied with electricity by the electric generator with the determined maximum electrical intensity of the electric current;
comparing this maximum engine torque with a required engine torque envelope permitted by the gas generator;
adapting said maximum electrical intensity as a function of this comparison in order to comply with the required envelope; and
starting the gas generator with the electric machine supplied by said at least one electrical energy source following this adaptation.

The power plant comprising the turboshaft engine, the electric machine and the electric generator may equip a vehicle, for example an aircraft, in order to rotate a propeller and/or a rotor, for example. The power plant may also be provided with a calculator comprising or connected to a memory. The memory may comprise instructions or a computer program enabling the calculator to implement this method.

The electric generator may comprise a single electrical energy source or several electrical energy sources arranged in parallel with each other. Each electrical energy source supplies an electric current, for example a direct electric current, to supply electricity to the electric machine when starting the gas generator of the turboshaft engine.

Each electrical energy source may comprise one or more sensors for directly or indirectly measuring one or more characteristics of this electrical energy source. For example, such a characteristic of an electrical energy source may be chosen from at least its charge level, temperature and ageing.

Depending on one or more characteristics of such an electrical energy source and pre-established first charts or first laws stored in the memory, the calculator determines the maximum electrical intensity of the electric current that this electrical energy source can deliver.

When the electric generator comprises a single electrical energy source, the maximum electrical intensity of the electric current supplied by the electric generator is equal to the maximum individual electrical intensity of the electric current of this single electrical energy source.

When the electric generator comprises several electrical energy sources, the maximum electrical intensity of the electric current supplied by the electric generator is equal to the sum of the maximum individual electrical intensities of the electric currents of these electrical energy sources.

Next, the calculator determines, as a function of this maximum electrical intensity that the electric generator can deliver and pre-established second charts or second laws stored in the memory, the maximum engine torque that the electric machine provides when it is supplied with an electric current having the abovementioned maximum electrical intensity.

The calculator then compares this maximum engine torque with a required engine torque envelope permitted by the gas generator, that is stored in the memory. This required envelope is delimited by a maximum torque curve and a minimum torque curve that need to be complied with when the gas generator is driven by the electric machine. Each of these torque curves may, for example, decrease as the speed of rotation of the gas generator increases. The torque curves may be established by tests, calculations and/or simulations, for example.

Next, as a function of this comparison, the calculator may control the electric generator, directly or via a dedicated control unit, in order to adapt, and therefore modify, the maximum electrical intensity of the electric current that the electric generator supplies. This maximum electrical intensity is modified in order to correspond, according to the second charts or the second laws, to an engine torque less than or equal to the torque values of the maximum torque curve and greater than or equal to the torque values of the minimum torque curve. In this way, the engine torque supplied by the electric machine complies with the required envelope, being situated between the maximum and minimum torque curves.

Finally, the electric machine is supplied by the electric generator and mechanically drives the drive shaft of the gas generator in order to start it while complying with the required permissible engine torque envelope. Therefore, no damage should be expected to the mechanical transmission system between the electric machine and the gas generator. Similarly, the gas generator is started efficiently because the phenomenon of the flame being blown out can be avoided.

The method according to the disclosure may comprise one or more of the following features, taken individually or in combination.

According to one possibility, the adaptation may comprise a step of defining a target maximum electrical intensity of the electric current that the electric generator needs to supply in order for the electric machine to transmit, when it is supplied by an electric current with this target maximum electrical intensity, a maximum engine torque complying with the required envelope, and situated, for example, on the maximum torque curve. This definition is performed by the calculator, using the second charts or the second laws, and the maximum torque curve.

According to one possibility compatible with the preceding possibilities, the electric generator may comprise several electrical energy sources, and the adaptation then comprises a step of supplying electricity wherein one or more of these electrical energy sources supplies electricity to the electric machine, when the maximum engine torque is higher than the maximum torque curve of the required envelope. This step of supplying electricity is carried out as a function of the maximum electrical intensity of the electric current supplied by the electric generator, so that the electric machine supplies a maximum engine torque to the gas generator within the required envelope.

The electrical energy sources are electrically connected in parallel with each other so as to jointly supply the electric machine. The electric generator comprises source switches arranged respectively between the electrical energy sources and the electric machine. Each source switch may comprise a contactor, a relay or a circuit switch that can be controlled remotely, using the calculator, for example, in order to open or close the contactor, the relay or the circuit switch so as to allow or prevent an electric current from flowing between the terminals of this source switch, thus allowing or preventing electricity from being supplied to the electric machine by the electrical energy source to which this source switch is connected.

Therefore, when the determined maximum engine torque is higher than the maximum torque curve of the required envelope, the step of supplying electricity may comprise steps for electrically connecting or disconnecting the necessary number of electrical energy sources, by means of the source switches, so that the sum of the maximum individual electrical intensities of the electric currents of the electrical energy sources electrically connected to the electric machine, or, if applicable, the maximum individual electrical intensity of the electric current of a single electrical energy source connected to the electric machine, allows the maximum engine torque of the electric machine to be within the required envelope, according to the second charts or the second laws. The step of supplying electricity may possibly comprise iterative calculations of this sum, varying the connected electrical energy sources until a suitable sum is obtained. During this step of supplying electricity, the sum of the maximum individual electrical intensities of the electric currents of the electrical energy sources electrically connected to the electric machine, or, if applicable, the maximum individual electrical intensity of the electric current of the single electrical energy source connected to the electric machine, is equal to the target maximum electrical intensity, for example.

To this end, the step of supplying electricity may comprise a connection/disconnection sub-step for electrically connecting or disconnecting the source switches depending on their initial states, i.e., depending on whether the source switches are electrically open or closed. The calculator is connected with each source switch via a wired or wireless link, in order to check their state and control them so as to electrically connect them to or disconnect them from an electrical energy source.

According to one possibility compatible with the preceding possibilities, the electric generator comprises a single electrical energy source, and the adaptation then comprises a discharge step to electrically discharge the single electrical energy source, when the maximum engine torque is greater than the torque values of the maximum torque curve of the required envelope, until a required charge level is reached enabling it to supply an electric current with a maximum individual electrical intensity corresponding to a maximum engine torque less than or equal to the torque values of the maximum torque curve of the required envelope, in order for the electric machine to supply an engine torque within the required envelope to the gas generator. The gas generator is started once the discharge step has been completed.

The discharge step may discharge the single electrical energy source into an on-board network of the vehicle equipped with the power plant, for example, or into a dedicated discharge device, such as one or more electrical consumers. Once the required charge level is reached, the discharge step is complete, and the gas generator may be started without the risk of damage to the gas generator or the mechanical transmission system.

The required charge level of the electrical energy source is defined so that the electrical energy source delivers an electric current with a maximum individual electrical intensity corresponding to a maximum engine torque within the required envelope, for example situated on the maximum torque curve. The calculator may calculate the required charge level as a function of the first charts or first laws relating to this single electrical energy source, the characteristic or characteristics of this single electrical energy source and either the second charts or second laws and the maximum torque curve, or the target maximum electrical intensity.

Moreover, the calculator may transmit this required charge level and a current charge level of the single electrical energy source to a display in order to display this required charge level alongside the current charge level so as to indicate them to an operator or pilot of the vehicle.

The calculator may also calculate a necessary time period needed to reach this required charge level by using a measurement of an electrical intensity of an electrical discharge current supplied by the single electrical energy source during the discharge step and the current charge level, and possibly the characteristic or characteristics of this single electrical energy source. The calculator may possibly transmit this necessary time period to the display in order to display it so as to indicate to an operator or pilot of the vehicle the amount of time before starting can be carried out.

Alternatively, this discharge step may also be carried out in the context of an electric generator comprising several electrical energy sources in order to reduce the maximum individual electrical intensity of an electric current supplied by one of these electrical energy sources.

According to one possibility compatible with the preceding possibilities, the electric generator comprises a single electrical energy source and at least one dissipating component arranged electrically in parallel with the electric machine, and the adaptation comprises a connection step for electrically connecting at least one dissipating component to the electric generator when the maximum engine torque is greater than the torque values of the maximum torque curve of the required envelope, the dissipating component or components being supplied with electricity by the electric generator. Following this connection step, the single electrical energy source delivers an electric current to terminals of the connected dissipating component or components and to the electric machine. Some of this electric current delivered by the single electrical energy source therefore flows through the dissipating component or components, making it possible to dissipate some of the electrical energy of this single electrical energy source. The gas generator is started after the connection step.

A dissipation switch is arranged electrically in series between the electric generator and at least one dissipating component.

The calculator determines, for example, the value of the electrical intensity of the electric current delivered by the single electrical energy source that needs to be diverted from the electric machine and, consequently, the number of dissipating components that need to be connected to the single electrical energy source. The calculator may calculate this value of the electrical intensity of the electric current delivered by the single electrical energy source as a function of characteristics of the dissipating components of the electric generator, and either the target maximum electrical intensity or the second charts or second laws and the maximum torque curve.

The calculator then controls the necessary number of dissipation switches during the connection step in order for the necessary number of dissipating components to be connected to the single electrical energy source.

As a result, the dissipating components dissipate the surplus electrical intensity of the electric current supplied by the single electrical energy source during the dissipation step.

The dissipating components comprise, for example, one or more electrical resistors.

Alternatively, this dissipation step may also be carried out in the context of an electric generator comprising several electrical energy sources in order to dissipate some of the electrical energy supplied by one of these electrical energy sources.

According to one possibility compatible with the preceding possibilities, an electrical energy source may comprise at least one rechargeable source, for example an electric battery or a supercapacitor. Such a rechargeable source advantageously helps optimize the mass of the electrical energy source, in particular by avoiding dead weight. An electrical energy source may also comprise a primary energy storage device, that is therefore non-rechargeable.

Furthermore, when the power plant equips a vehicle, the electric generator may supply electricity to an on-board network of the vehicle and/or one or more items of equipment of the vehicle before the turboshaft engine is started. The electrical intensity of the electric current consumed in this way is generally low, but it may sometimes have an electrical intensity in the region of 10% of the electrical intensity of the starting current. This electrical intensity of the electric current consumed in this way by the on-board network of the vehicle and/or by one or more items of equipment of the vehicle may in this case be taken into account in the context of the disclosure, and deducted from the maximum electrical intensity of the electric current supplied by the electric generator, in order to calculate the maximum engine torque supplied by the powered electric machine.

An object of the present disclosure is also a power plant provided with at least one turboshaft engine comprising a gas generator and an adaptive starting circuit comprising a calculator, an electric machine connected mechanically to a drive shaft of the gas generator and electrically to an electric generator provided with at least one electrical energy source and configured to start the gas generator.

This power plant is configured to implement the adaptive starting method for a turboshaft engine described above, by means of the adaptive starting circuit.

According to a first variant, the electric generator may comprise several electrical energy sources arranged in parallel with each other as well as source switches electrically connecting each of the electrical energy sources to the electric machine. The source switches are controlled independently of each other by the calculator to be electrically open or closed.

According to a second variant, the electric generator may comprise a single electrical energy source.

Irrespective of the variant, the electric generator and the electric machine may be electrically connected to an electricity network, for example an on-board network of a vehicle, or to electrical consumers.

The electric generator may also comprise one or more dissipating components and one or more dissipation switches. The dissipating component or components may be arranged electrically in parallel with the electric machine, a dissipation switch electrically connecting one or more dissipating components to the electric generator. Alternatively, the dissipating component or components may be arranged electrically in series with the electric machine, a dissipation switch electrically connecting the electric generator to an electric line short circuiting one or more dissipating components.

The dissipation switch or switches are controlled independently of each other by the calculator to be electrically open or closed.

A dissipating component may comprise one or more electrical resistors.

Irrespective of the variant, an electrical energy source may comprise at least one rechargeable source, for example an electric battery, and/or a primary energy storage device.

An object of the present disclosure is finally a vehicle provided with the power plant described above.

### BRIEF DESCRIPTION OF THE DRAWINGS

The disclosure and its advantages appear in greater detail in the context of the following description of embodiments given by way of illustration and with reference to the accompanying figures, wherein:

FIG. 1 is a diagram showing a power plant according to the disclosure;

FIG. 2 is a diagram showing a power plant according to the disclosure;

FIG. 3 is a diagram showing a power plant according to the disclosure;

FIG. 4 is a diagram showing a power plant according to the disclosure;

FIG. 5 is a block diagram of an adaptive starting method for the power plant of FIGS. 1 to 4; and

FIG. 6 is a graph showing the required permissible engine torque envelope for starting a turboshaft engine.

### DETAILED DESCRIPTION

Elements that are present in more than one of the figures are given the same references in each of them.

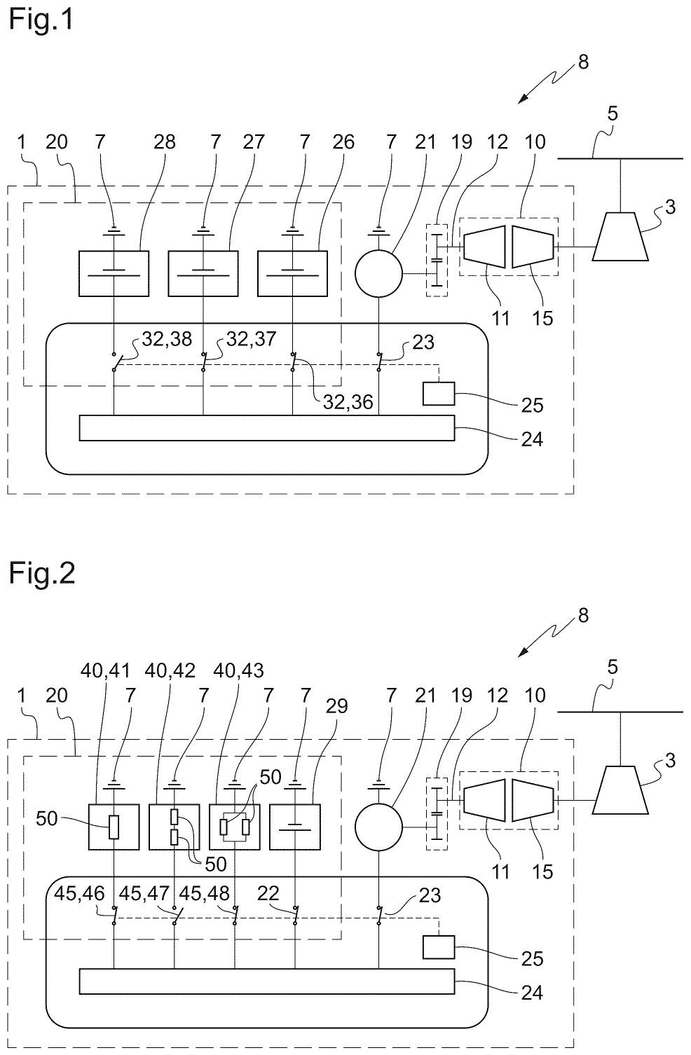

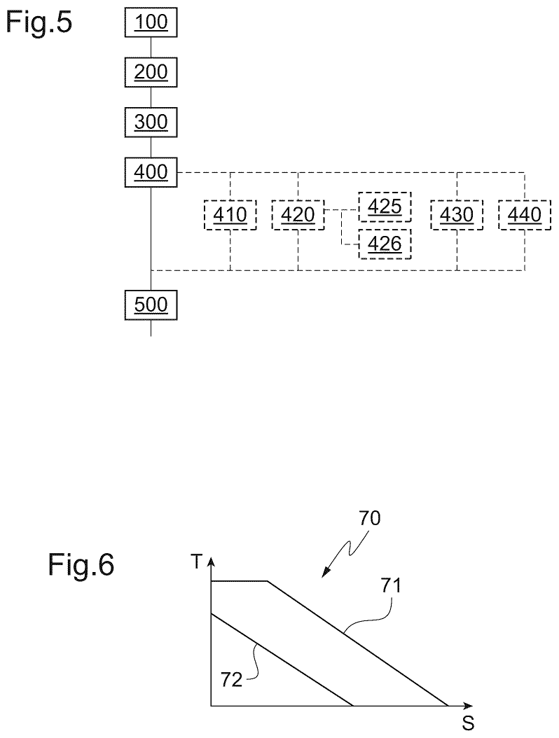

FIGS. 1 to 4 show various embodiments of a power plant 1 of the disclosure. FIG. 5 shows a block diagram of an adaptive starting method for such a power plant 1.

Irrespective of the embodiment, the power plant 1 comprises at least one turboshaft engine 10. The power plant 1 may be arranged within any system driven by a turboshaft engine, and in particular within a vehicle 8. For example, such a vehicle 8 may be a land, sea or air vehicle. For example, the vehicle 8 may be an aircraft provided with a rotary wing 5 rotated by the turboshaft engine 10, possibly via a power transmission system 3.

The embodiments of the power plant 1 shown in the figures comprise a single turboshaft engine 10, although a power plant 1 according to the disclosure may comprise two or more turboshaft engines 10.

A turboshaft engine 10 comprises a gas generator 11 and a power turbine 15 connected mechanically to the power transmission system 3 in order to rotate the rotary wing 5 according to the example shown. The power turbine 15 may be referred to as “free”, i.e., not connected mechanically to the gas generator 11. Alternatively, the power turbine 15 may be connected mechanically to the gas generator 11.

The gas generator 11 may successively comprise a compressor, a fuel combustion chamber and an expansion turbine, that are not shown in the figures. The expansion turbine is constrained to rotate with the compressor by a connecting shaft.

Irrespective of its arrangement, the power plant 1 according to the disclosure also comprises an electric machine 21 that serves at least as an electric starter for the turboshaft engine 10. The electric machine 21 may comprise an electric motor that operates only in motor mode to start the turboshaft engine 10. Alternatively, the electric machine 21 may operate, as required, in motor mode to start the turboshaft engine 10, and in electrical power generation mode to transform mechanical energy transmitted by the turboshaft engine 10 into electrical energy.

A mechanical transmission system 19 is arranged between the electric machine 21 and a drive shaft 12 of the gas generator 11. Such a mechanical transmission system 19 may comprise gears, pinions and/or toothed wheels for reducing the speed of rotation of the electric machine 21 transmitted to the drive shaft 12.

The power plant 1 also comprises a calculator 25. By way of example, the calculator 25 may comprise at least one processor and at least one memory, at least one integrated circuit, at least one programmable system, or at least one logic circuit, these examples not limiting the scope to be given to the term “calculator”. The term “processor” may refer equally to a central processing unit or CPU, a graphics processing unit or GPU, a digital signal processor or DSP, a microcontroller, etc.

As an alternative to the memory that the calculator 25 may have, the power plant 1 may comprise a memory (not shown) connected to the calculator 25.

The power plant 1 according to the disclosure also comprises an electric generator 20 electrically connected to the electric machine 21 in order to supply it with electrical energy. The electric generator 20 may comprise one or more electrical energy sources 26-29, each electrical energy source 26-29 comprising one or more electric batteries, for example.

Such an electrical energy source 26-29 may also comprise one or more conventional sensors (not shown) for measuring one or more characteristics of this electrical energy source 26-29. Such a sensor can supply a raw signal carrying raw measurements made by this sensor. A sensor may also comprise an integrated calculator to process these raw measurements, for example via conventional filtering or sampling, or the application of transformations, and supply a processed signal carrying these processed raw measurements.

For example, an electrical energy source 26-29 may comprise a temperature sensor, possibly provided with a thermometer, for measuring a temperature inside the electrical energy source 26-29.

According to another example, an electrical energy source 26-29 may comprise a charge sensor for measuring an electrical charge level of the electrical energy source 26-29, i.e., the quantity of electrical energy that it comprises.

According to another example, an electrical energy source 26-29 may comprise an ageing sensor for measuring an ageing state of the electrical energy source 26-29. Such an ageing sensor may, for example, calculate the level of ageing of the electrical energy source 26-29 as a function of internal parameters, such as its internal resistance and its state of charge, for example. The level of ageing may be taken into account in order to determine the value of the maximum electrical intensity of the electric current that this electrical energy source 26-29 can supply.

The electric generator 20 may comprise a single electrical energy source 29 as shown in FIGS. 2 to 4. Alternatively, the electric generator 20 may comprise at least two electrical energy sources 26-28 arranged electrically in parallel with each other. The electric generator 20 may, for example, comprise three electrical energy sources 26-28 as shown in FIG. 1.

Each electrical energy source 26-29 and the electric machine 21 may be electrically connected to a common electrical ground 7 and to an electricity network 24 of the power plant 1. The electricity network 24 may be an on-board electrical network of the vehicle 8.

Such an electrical energy source 26-29 may therefore supply an electric current, for example a direct electric current, in order to power the electric machine 21, in particular.

A starting switch 23 is arranged electrically in series between the electric machine 21 and the electricity network 24. When the starting switch 23 is electrically closed, the electric machine 21 may be supplied with electricity by the electric generator 20 so as to rotate the gas generator 11 during a starting phase. The calculator 25 may control the starting switch 23 to electrically open and close it as the starting phase progresses. To this end, the calculator 25 may be in wired or wireless communication with the starting switch 23.

According to the illustration in FIG. 1, a first embodiment of the power plant 1 may comprise an electric generator 20 provided with three electrical energy sources 26, 27, 28 and three source switches 32 arranged between the electricity network 24 and the three electrical energy sources 26, 27, 28 respectively.

Reference number “32” denotes the source switches generally whereas reference numbers “36”, “37”, “38” specifically denote one of the three source switches.

Each source switch 32 therefore makes it possible to electrically connect or disconnect one electrical energy source 26, 27, 28 with the electricity network 24, in order to power the electric machine 21, for example.

The calculator 25 may control the source switches 32 using stored logic. The calculator 25 may be in wired or wireless communication with the source switches 32.

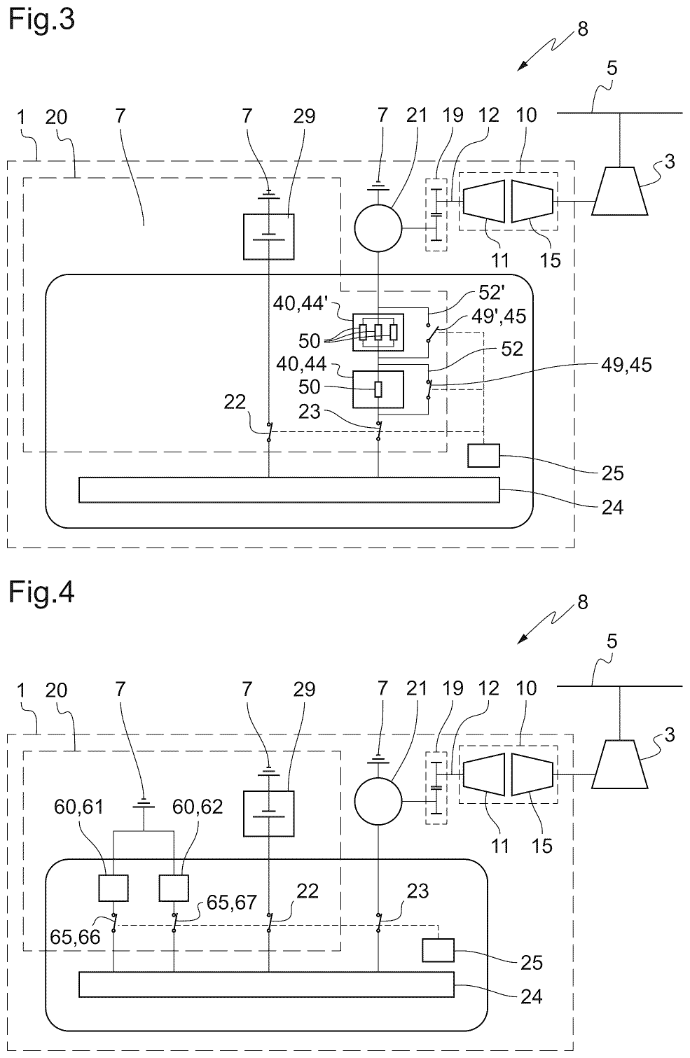

According to the illustrations in FIGS. 2 and 3, the power plant 1 according to the disclosure may comprise an electric generator 20 provided with dissipating components 40 and dissipation switches 45.

Reference number “40” denotes the dissipating components generally whereas reference numbers “41”, “42”, “43”, “44”, “44′” specifically denote one of the dissipating components. Similarly, reference number “45” denotes the dissipation switches generally whereas reference numbers “46”, “47”, “48”, “49”, “49′” specifically denote one of the dissipation switches.

The electric generator 20 also comprises a supply switch 22 arranged electrically in series between the electrical energy source 29 and the electricity network 24. This supply switch 22 is normally electrically closed, meaning that the electrical energy source 29 is electrically connected to the electricity network 24 in order to supply it with electric current. The calculator 25 may control the supply switch 22 to open it and thus electrically disconnect the electrical energy source 29 from electricity network 24, as required.

Each dissipation switch 45 therefore makes it possible to electrically connect or disconnect a dissipating component 40 with the electricity network 24. The calculator 25 may control the dissipation switches 45 using stored logic. The calculator 25 may be in wired or wireless communication with the dissipation switches 45. Each dissipating component 40 may comprise one or more electrical resistors 50, that may be arranged electrically in series or in parallel with each other, depending on the required electrical resistance value, corresponding to the desired electrical dissipation capacity.

According to a second embodiment of the power plant 1 shown in FIG. 2, the electric generator 20 may comprise a single electrical energy source 29, three dissipating components 41, 42, 43 and three dissipation switches 46, 47, 48 arranged between the electricity network 24 and the three dissipating components 41, 42,43 respectively. The three dissipating components 41, 42, 43 and the three dissipation switches 46, 47, 48 are thus arranged electrically in parallel with the electric machine 21.

When a dissipation switch 45 is controlled to be electrically closed, the dissipating component 40 arranged electrically in series with this dissipation switch 45 is electrically connected to the electricity network 24 and may be powered by the electrical energy source 29 such that an electric current flows through the dissipating component 40. This dissipating component 40 then consumes and dissipates this electric current flowing through it, and therefore the electrical energy, for example in the form of heat.

According to a third embodiment of the power plant 1 shown in FIG. 3, the electric generator 20 may comprise a single electrical energy source 29, two dissipating components 44, 44′ arranged electrically in series with the electric machine 21 and two dissipation switches 49, 49′ arranged electrically in parallel with the two dissipating components 44, 44′ respectively. The two dissipation switches 49,49′ are each positioned on an electric line 52, 52′ short circuiting one of the dissipating components 44,44′.

When a dissipation switch 45 is controlled to be electrically open, the dissipating component 40 arranged electrically in parallel with this dissipation switch 45 is electrically connected to the electricity network 24 and to the electric machine 21 and may be powered by the electrical energy source 29, the electric line 52, 52′ not being electrically connected to the electricity network 24 or therefore to the electrical energy source 29, such that an electric current flows through the dissipating component 40. This dissipating component 40 then consumes and dissipates this electric current flowing through it, and therefore the electrical energy, for example in the form of heat. Conversely, when a dissipation switch 45 is controlled to be electrically closed, the electric line 52, 52′ short circuiting the dissipating component 40 arranged electrically in parallel with this dissipation switch 45, and this dissipating component 40, are electrically connected to the electricity network 24 and to the electric machine 21 and may be supplied by the electrical energy source 29. However, the electric current then flows through the electric line 52, 52′ without passing through the dissipating component 40. This dissipating component 40 then does not consume or dissipate electric current or, therefore, electrical energy.

Similarly, the electric generator 20 may comprise dissipating components 40 arranged electrically in series with an electrical energy source 26-29 and dissipation switches 45 respectively positioned on an electric line 52, 52′ arranged electrically in parallel with these dissipating components 40.

According to the illustration in FIG. 4, a fourth embodiment of the power plant 1 may comprise an electric generator 20 provided with a single electrical energy source 29, two electrical consumers 60 and two discharge switches 65 arranged between the electricity network 24 and the two electrical consumers 60 respectively.

Reference number “60” denotes the electrical consumers generally whereas reference numbers “61”, “62” specifically denote one of the two electrical consumers. Similarly, reference number “65” denotes the discharge switches generally whereas reference numbers “66”, “67” specifically denote one of the two discharge switches.

The electric generator 20 also comprises a supply switch 22 arranged electrically in series between the electrical energy source 29 and the electricity network 24. This supply switch 22 is, for example, closed by default, and may be opened, if required, to electrically disconnect the electrical energy source 29 from the electricity network 24.

Each discharge switch 65 therefore makes it possible to electrically connect or disconnect an electrical consumer 60 with the electricity network 24. The calculator 25 may control the discharge switches 65 using stored logic. The calculator 25 may be in wired or wireless communication with the discharge switches 65.

When a discharge switch 65 is controlled to be electrically closed, the electrical consumer 60 arranged electrically in series with this discharge switch 65 is electrically connected to the electricity network 24 and may be powered by the electrical energy source 29 such that an electric current flows through the electrical consumer 60. This electrical consumer 60 consumes some of the electrical energy supplied by the electrical energy source 29. Each electrical consumer 60 may comprise one or more items of electrical equipment, such as an air-conditioning system, screens, a radio communication system, lights, fans, hydraulic pumps.

FIG. 5 shows an adaptive starting method for the power plant 1. Instructions or a computer program relating to this method may be stored in a memory of the calculator 25 or in a memory connected to this calculator 25. The calculator 25 may then execute these instructions or this program in order to start the gas generator 11 of the power plant 10.

This method comprises five main steps.

Firstly, the method comprises determining 100 a maximum electrical intensity of the electric current that can be delivered by the electric generator 20. This maximum electrical intensity is determined using the calculator 25 as a function of at least one characteristic of said at least one electrical energy source 26-29. For example, the characteristic or characteristics of an electrical energy source 26-29 may be chosen from a list comprising at least its charge level, temperature and ageing.

The characteristic or characteristics of the electrical energy source or sources 26-29 are, for example, measured continuously or regularly by means of the sensor or sensors of the electrical energy source or sources 26-29. Each sensor then transmits an electrical, optical, digital or analog signal carrying information relating to the measured characteristic to the calculator 25, via wired or wireless means.

The method may also comprise a step of measuring one or more characteristics of the electrical energy source or sources 26-29, that is carried out prior to this determination step 100.

When the electric generator 20 comprises several electrical energy sources 26-28, the maximum electrical intensity of an electric current that can be delivered by the electric generator 20 is equal to the sum of the maximum individual electrical intensities of the electric currents supplied by these electrical energy sources 26-28. In this case, the step of measuring may also be carried out for each of these electrical energy sources 26-28.

When the electric generator 20 comprises a single electrical energy source 29, the maximum electrical intensity of the electric current supplied by the electric generator 20 is equal to the maximum individual electrical intensity of the electric current of this single electrical energy source 29.

During this determination step 100, the calculator 25 uses pre-established first charts or first laws stored in the memory. These pre-established first charts or first laws are specific to each electrical energy source 26-29. These first charts or first laws define the maximum individual electrical intensity of the electric current that each electrical energy source 26-29 can supply as a function of its measured characteristic or characteristics.

Next, the method comprises a step of calculating 200 a maximum engine torque supplied by the electric machine 21 to the drive shaft 12 when the electric machine 21 receives an electric current having the determined maximum electrical intensity.

During this step of calculating 200, the calculator 25 uses pre-established second charts or second laws stored in the memory. These pre-established second charts or second laws are specific to the electric machine 21 of the power plant 1. These second charts or second laws define the maximum engine torque that the electric machine 21 can transmit as a function of the maximum electrical intensity of the electric current supplying the electric machine 21.

Then, during a comparison step 300, the previously calculated maximum engine torque is compared by the calculator 25 to a required engine torque envelope 70 permitted by the gas generator 11.

An example of such a required envelope 70 is shown in FIG. 6. The engine torque permitted by the gas generator 11 is represented on the Y-axis while its speed of rotation is represented on the X-axis. This required envelope 70 is delimited by a maximum torque curve 71 and a minimum torque curve 72 that need to be complied with when the gas generator 11 is driven by the electric machine 21. These torque curves 71, 72 decrease as the speed of rotation of the gas generator 11 increases.

This comparison step 300 therefore makes it possible to determine whether the maximum engine torque is within the required envelope 70, i.e., less than or equal to the torque values of the maximum torque curve 71 and greater than or equal to the torque values of the minimum torque curve 72, or lies outside this required envelope 70. In the latter scenario, the maximum engine torque may be less than the torque values of the minimum torque curve 72 and greater than the torque values of the maximum torque curve 71.

During an adaptation step 400, the electrical intensity of the electric current supplied by the electric generator 20 is adapted in order to comply with the required envelope as a function of the comparison step 300. This adaptation step 400 is carried out when the maximum engine torque is greater than the torque values of the maximum torque curve 71 of the required envelope 70.

When the maximum engine torque is within the required envelope 70, no adaptation of the electric current is necessary. The gas generator 11 can be started without risk of damage to the power plant 1 or starting difficulties.

When the maximum engine torque is less than the torque values of the minimum torque curve 72, the electric generator 20 of the power plant 1 cannot supply an electric current of sufficient electrical intensity to start the gas generator 11. The calculator 25 then transmits a signal to an alerter to inform an operator or pilot of the vehicle 8 of this, if applicable.

When the maximum engine torque is greater than the torque values of the maximum torque curve 71, there is a risk of damage to the mechanical transmission system 19 between the electric machine 21 and the gas generator 11, or indeed to the gas generator 11. The calculator 25 may then transmit a signal to an alerter to indicate this to an operator or pilot of the vehicle 8, if applicable. The operator or pilot may possibly decide to act manually on one of the electrical energy sources 26-29 to cut off its power supply, for example, or partially discharge it depending on the information supplied by the calculator 25.

This adaptation step 400 advantageously helps to reduce the maximum electrical intensity of the electric current supplied by the electric generator 20 to the electric machine 21, when necessary, and therefore to reduce the maximum engine torque that the electric machine 21 can transmit, in order for it to be within the required envelope 70. The gas generator 11 can therefore be started without risk of damage to the mechanical transmission system 19, in particular. The calculator 25 controls the electric generator 20 to adapt the maximum electrical intensity of the electric current supplied by at least one energy source 26-29.

This adaptation step 400 may comprise a step of defining 410 a target maximum electrical intensity of the electric current that the electric generator 20 needs to supply. The calculator 25 transforms the value of the maximum engine torque complying with the required envelope 70 and situated, for example, on the maximum torque curve 71, into this target maximum electrical intensity, using the second charts or the second laws.

Furthermore, with a power plant 1 that has several electrical energy sources 26, 27, 28 of the type shown in FIG. 1, the adaptation step 400 may comprise a step of supplying electricity 420 to supply electricity to the electric machine 21 with one or more of the electrical energy sources 26, 27, 28. During this step of supplying electricity 420, one or more source switches 36, 37, 38 are connected or disconnected in order for a sufficient number of the electrical energy sources 26, 27, 28 to power the electric machine 21, and thus obtain a maximum electrical intensity corresponding to a maximum engine torque complying with the required envelope 70. This maximum electrical intensity is, for example, equal to the target maximum electrical intensity.

To this end, the step of supplying electricity 420 may comprise connection 425 and disconnection 426 sub-steps for electrically connecting or disconnecting the source switches 36, 37, 38 by means of the calculator 25, as a function of the initial state of each of these source switches 36, 37, 38, i.e., depending on whether the source switches 36, 37, 38 are electrically open or closed. The calculator 25 is connected with each of these source switches 36, 37, 38 by a wired or wireless link, in order to check their state and control them so as to electrically connect them to or disconnect them from an electrical energy source 26,27,28.

In the specific example shown in FIG. 1, the sum of the maximum individual electrical intensities of the electric currents supplied by the first electrical energy source 26 and by the second electrical energy source 27 enables the electric machine 21 to supply a maximum engine torque within the required envelope 70.

Therefore, during the step of supplying electricity 420, or during the connection 425 and disconnection 426 sub-steps, the calculator 25 controls the opening of the third source switch 38, the three source switches 36, 37, 38 being initially closed, so that the third electrical energy source 28 does not supply electric current to the electricity network 24, and, therefore, to the electric machine 21. The first and second source switches 36, 37 remain closed in order for the first and second electrical energy sources 26,27 to jointly supply their electric currents to the electricity network 24 and, therefore, to the electric machine 21, in order to comply with the required envelope 70.

According to another example corresponding to the power plant 1 shown in FIG. 4, the electric generator 20 of which comprises a single electrical energy source 29, the adaptation step 400 comprises a discharge step 430 for discharging the single electrical energy source 29 until it reaches a required charge level enabling it to supply an electric current with the maximum electrical intensity corresponding to a maximum engine torque within the required envelope 70 and, for example, equal to the target maximum electrical intensity. To this end, during the discharge step 430, the calculator 25 may control the discharge switches 65 to close them electrically as a function of the comparison step 300.

In the specific example shown in FIG. 4, the calculator 25 commands the first discharge switch 66 and second discharge switch 67 to close in order for the first electrical consumer 61 and the second electrical consumer 62 to be electrically connected to the electricity network 24 and therefore consume the electrical energy stored in the single electrical energy source 29. Depending on the electrical characteristics of each of the two electrical consumers 61, 62 and the electrical intensities of the electric currents passing through them, the calculator 25 can determine the necessary time period needed to reach the required charge level. The calculator 25 may transmit this necessary time period to a display in order to display it for an operator or pilot of the vehicle 8.

Once the required charge level is reached, the discharge step 430 is stopped, the calculator 25 commands the first discharge switch 66 and the second discharge switch 67 to open in order for the first and second electrical consumers 61, 62 to be electrically disconnected from the electricity network 24 and therefore consume no more electrical energy.

As an alternative or in addition to the electrical consumers 60, during the discharge step 430, the single electrical energy source 29 may supply an electric current to an on-board network or to items of equipment of the vehicle 8 that are conventionally used, such as an air-conditioning system, screens, etc. This alternative avoids the use of electrical consumers 60 that have the sole function of reducing the charge level of the electrical energy source 29.

According to another example corresponding to the power plant 1 shown in FIGS. 2 and 3, the electric generator 20 of which comprises a single electrical energy source 29 and dissipating components 40, the adaptation step 400 comprises a connection step 440 for electrically connecting one or more dissipating components 40 with the electric generator 20. Once connected to the single electrical energy source 29, a dissipating component 40 makes it possible to dissipate some of the electrical energy supplied by the single electrical energy source 29, for example by releasing heat. The electric current supplied by the single electrical energy source 29 can thus be distributed and flow through one or more dissipating components 40 and through the electric machine 21.

The calculator 25 then controls the dissipation switches 45 as a function of the comparison 300 in order for the electric currents passing through one or more dissipating components 40 to together have an electrical intensity greater than or equal to the difference between the maximum electrical intensity determined during the determination step 100 and an electrical intensity corresponding to an engine torque value situated on the maximum torque curve 71 and, for example, equal to the target maximum electrical intensity, and less than the difference between the maximum electrical intensity determined during the determination step 100 and an electrical intensity corresponding to an engine torque value situated on the minimum torque curve 72. Therefore, for example, the electric current supplying the electric machine 21 has a maximum electrical intensity equal to the target maximum electrical intensity enabling the electric machine 21 to supply an engine torque within the required envelope 70 if the electric currents passing through the dissipating component or components 40 connected to the electrical energy source 22 together have an electrical intensity greater than or equal to the difference between the determined maximum electrical intensity and an electrical intensity corresponding to an engine torque value situated on the maximum torque curve 71.

In the specific example shown in FIG. 2, the calculator 25 commands the first dissipation switch 46 and the third dissipation switch 48 to close, the second dissipation switch 47 remaining electrically open. As a result, an electric current passes through the first and third dissipating components 41, 43. No electric current flows through the second dissipating component 42.

In the specific example shown in FIG. 3, the calculator 25 commands the fifth dissipation switch 49′ to open, the fourth dissipation switch 49 remaining closed. As a result, an electric current passes through the fifth dissipating component 44′ and the first electric line 52. No electric current then passes through the fourth dissipating component 44 and the second electric line 52′.

Irrespective of how the electrical intensity supplied by the electric generator 20 to the electric machine 21 is adapted, during a starting step 500, the gas generator 11 is rotated by the electric machine 21. To this end, the calculator 25 may control the starting switch 23 to electrically connect the electric machine 21 to the electric generator 20, via the electricity network 24.

When the adaptation step 400 comprises the step of supplying electricity 420, the starting step 500 is carried out once this this step of supplying electricity 420 has been carried out, i.e., once the necessary source switch or switches 32 are electrically closed and the other source switch or switches 32 are electrically open.

When the adaptation step 400 comprises the discharge step 430, the starting step 500 is carried out once this discharge step 430 has been carried out and completed, i.e., once the discharge switches 65 have been electrically opened and the required charge level of the electrical energy source has been reached.

Finally, when the adaptation step 400 comprises the connection step 440, starting 500 is carried out once this connection step 440 has been carried out, i.e., once the necessary dissipation switch or switches 45 are electrically closed and the other dissipation switch or switches 45 are electrically open.

Naturally, the present disclosure is subject to numerous variations as regards its implementation. Although several embodiments are described above, it should readily be understood that it is not conceivable to identify exhaustively all the possible embodiments. It is naturally possible to envisage replacing any of the means described by equivalent means without going beyond the ambit of the present disclosure.

What is claimed is:

1. An adaptive starting method for a turboshaft engine comprising a gas generator, an electric machine connected mechanically to a drive shaft of the gas generator and electrically to an electric generator provided with at least one electrical energy source,
the method comprising the following steps:
determining a maximum electrical intensity of an electric current that can be delivered by the electric generator as a function of at least one characteristic of the electrical energy source(s);
calculating a maximum engine torque supplied by the electric machine to the drive shaft when the electric machine is supplied with electricity by the electric generator with the maximum electrical intensity;
comparing the maximum engine torque with a required engine torque envelope permitted by the gas generator;
adapting the maximum electrical intensity as a function of the comparison in order to comply with the required envelope; and
starting the gas generator with the electric machine supplied by the electric generator following the adaptation.

2. The method according to claim 1,
wherein the adaptation comprises defining a target maximum electrical intensity of the electric current that the electric generator needs to supply in order for the electric machine to transmit, when the electric machine is supplied by the electric current with the target maximum electrical intensity, a maximum engine torque that complies with the required envelope.

3. The method according to claim 1,
wherein the electric generator comprises several electrical energy sources, and the adaptation comprises supplying electricity to the electric machine with one or more of the electrical energy sources, when the maximum engine torque is higher than a maximum torque curve of the required envelope, as a function of the maximum individual electrical intensity of the electric current supplied by each of the electrical energy sources, so that the electric machine supplies a maximum engine torque to the gas generator within the required envelope.

4. The method according to claim 1,
wherein the electric generator comprises a single electrical energy source, and the adaptation comprises discharging the single electrical energy source when the maximum engine torque is higher than a maximum torque curve delimiting the required envelope, until a required charge level is reached enabling it to supply an electric current allowing the electric machine to generate a torque that lies within the required envelope, the starting of the gas generator being carried out once the discharge is complete.

5. The method according to claim 1,
wherein the electric generator comprises a single electrical energy source, and the adaptation comprises connecting the electric machine with at least one dissipating component electrically connected to the electric machine when the maximum engine torque is higher than a maximum torque curve of the required envelope, the dissipating component(s) being supplied with electricity by the electric generator.

6. The method according to claim 5,
wherein, during the connection step, a calculator of a power plant comprising the turboshaft engine, the electric machine and the electric generator controls at least one dissipation switch arranged electrically in series between the electric generator and the dissipating component(s) arranged electrically in parallel with the electric machine.

7. The method according to claim 5,
wherein, during the connection step, a calculator of a power plant comprising the turboshaft engine, the electric machine and the electric generator controls at least one dissipation switch arranged electrically in parallel with the dissipating component(s), the dissipating component(s) being arranged electrically in series with the electric machine, the dissipation switch(es) being positioned on an electric line short circuiting the dissipating component(s).

8. The method according to claim 5,
wherein the dissipating component(s) comprise(s) one or more electrical resistors.

9. The method according to claim 1,
wherein the characteristic(s) of the electrical energy source(s) is/are chosen from its state of charge, temperature and ageing.

10. The method according to claim 1,
wherein the electrical energy source(s) comprise(s) at least one electric battery.

11. A power plant provided with at least one turboshaft engine comprising a gas generator and an adaptive starting circuit comprising a calculator, the power plant comprising an electric machine connected mechanically to a drive shaft of the gas generator and electrically to an electric generator provided with at least one electrical energy source,
wherein the power plant is configured to implement the method according to claim 1.

12. The power plant according to claim 11,
wherein the electric generator comprises several electrical energy sources arranged in parallel with each other and source the power plant comprises switches respectively electrically connecting each of the electrical energy sources to the electric machine, the source switches being controlled by the calculator.

13. The power plant according to claim 11,
wherein the electric generator comprises at least one dissipating component arranged electrically in parallel with the electric machine, and at least one dissipation switch electrically connecting the dissipating component(s) to the electric generator, the dissipation switch(es) being controlled by the calculator.

14. The power plant according to claim 11,
wherein the electric generator comprises at least one dissipating component arranged electrically in series with the electric machine, and at least one dissipation switch arranged electrically in parallel with the dissipating component(s) and positioned on an electric line short circuiting the dissipating component(s), the dissipation switch(es) being controlled by the calculator.

15. The power plant according to claim 13,
wherein the dissipating component(s) comprise(s) one or more electrical resistors.

16. The power plant according to claim 11,
wherein the electrical energy source(s) comprise(s) at least one electric battery.

17. A vehicle provided with the power plant,
wherein the power plant is according to claim 11.
